(19) United States
(12) Patent Application Publication
(10) Pub. No.: US 2018/0005332 A1
(43) Pub. Date: Jan. 4, 2018

(54) MEDICAL CONDITION MANAGEMENT SYSTEM AND METHODS

(71) Applicants: Leonard John Testa, Greensboro, NC (US); Brad Eilerman, Union, KY (US)

(72) Inventors: Leonard John Testa, Greensboro, NC (US); Brad Eilerman, Union, KY (US)

(21) Appl. No.: 15/604,641

(22) Filed: May 24, 2017

Related U.S. Application Data
(60) Provisional application No. 62/340,843, filed on May 24, 2016.

(51) Int. Cl. G06Q 50/22; G06F 19/00

(52) U.S. Cl. CPC G06Q 50/22; G06F 19/322; G06F 19/34

(57) ABSTRACT

A system ranks pharmaceutical and other regimens for the treatment of chronic diseases (e.g., diabetes) to optimize the patient, medical, financial, and operational aspects of drug therapy using a combination of data impossible for a human to consume and process within any useful period of time. A scoring algorithm balances estimated cost, intolerance, benefit, and efficacy, using information from the patient's medical history, personal preference, drug manufacturers, clinical trial data, and other sources (e.g., insurance payment data) for every possible therapy and combination of therapies. This creates a patient specific regimen (i.e., solution or combination of therapies) that is cost effective with minimal side effects and maximal benefit which is specific to each patient instead of each doctor having a standard regimen for every patient (many of whom it is not effective for). Bodies change over time and the system can continually update the best personalized regimen.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to and hereby incorporates by reference in its entirety, U.S. Provisional Patent Application Ser. No. 62/340,843 entitled “MEDICAL CONDITION MANAGEMENT SYSTEM AND METHODS” filed on May 24, 2016.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to managing diabetes treatment for cost and effectiveness.

People with chronic medical conditions, such as diabetes, rely on medical professionals to prescribe therapies that balance the patient's medical, financial, and lifestyle needs. A patient who cannot afford a $2,000 per month drug will not take a $2,000 per month drug. A patient whose condition is not improved by a $20 per month drug will continue to have ongoing health problems. And a patient whose side effects from a given drug prevent the patient from partaking in activities that they deem important will not take the drug. In addition, a medical professional must take into account their own (and often their hospital's) financial and operational needs when recommending a drug therapy. That is, under pay for performance contracts, insurers will not reimburse a medical provider at the full contracted rate if the patient does not report an improved condition or if follow-up treatment is necessary.

The overwhelming number of potential therapies for many conditions (e.g., diabetes) combined with the different reimbursement structure and prescriptions drug coverage of various insurers makes it impossible for any medical professional to determine which therapy is most beneficial to the patient with acceptable side effects that is cost advantageous to the patient, the medical professional (e.g., the practitioner, medical practice, or hospital), and the insurer. For example, there are currently more than 60 drugs available to treat Type 2 Diabetes (T2D) in the United States. It is common for medical professionals to prescribe from 1 to 5 of these drugs together to treat one patient. There are more than 5.5 million different ways to choose 1 to 5 of these 60 drugs for a patient's therapy. Each of those combinations has its own price, efficacy, and side effects, along with other medical, financial, and lifestyle considerations, and each of which vary in cost on a per provider and per insurer basis. Additionally, the cost structures per insurer, per patient, and per provider often change on an annual basis if not more frequently given market price fluctuations in drug prices. It is impossible for a human doctor to evaluate these millions of options in a lifetime, much less in a matter of seconds or minutes as is required in an active medical practice. The result is that a sub-optimal therapy prescription is almost always made. This can lead to unnecessary expense for the patient, a longer time to treat the underlying medical condition, undesirable side effects, increased costs, and more.

Existing systems do not adjust for the patient's financial circumstances. Existing systems do not consider the patient's true cost based on the patient's insurance coverage and any negotiated price and discounting of the therapies. Existing systems do not account for the patient's ability to adhere to the therapy. For example, they do not take into account that a patient's history of failing to take a three-times-per-day medicine indicates that the patient will be unlikely to succeed in taking a three-times-per-day medicine in the future. Existing systems do not predict adverse events (e.g., allergic reactions) or benefits (e.g., cardiovascular health improvement).

### BRIEF SUMMARY OF THE INVENTION

Aspects of the present invention provide a system and method to rank pharmaceutical regimens for the treatment of chronic diseases (e.g., diabetes) to optimize the patient, medical, financial, and operational aspects of drug therapy. The invention uses a mathematical scoring system to balance estimated cost, intolerance, benefit, and efficacy, using information from the patient's medical history and personal preference. This creates a regimen that is cost effective with minimal side effects, maximal benefit, and easy adherence.

In one aspect, a medical condition management system includes a user interface, a therapy table, and a decision engine. The user interface is configured to receive patient data and output a rank ordered list of solutions. The therapy table is configured to store therapy data for each therapy of a plurality of therapies, said therapy data comprising price, side effects, multi-therapy compatibility, insurance discounts, insurance reimbursements, and efficacy. The decision engine is configured to receive the patient data from the user interface, received the therapy data from the therapy table, generate the rank ordered list of solutions from the received patient data and therapy data, and provide the rank ordered list of solutions to the user interface.

### BRIEF DESCRIPTION OF THE SEVERAL VIEWS OF THE DRAWINGS

FIG. 1 is a block diagram of a medical condition management system.

FIG. 2 is a screen capture of an individual user interface of a medical condition (e.g., diabetes) management system.

FIG. 3 is a partial flow chart of a decision engine of method medical condition (e.g., diabetes) management system.

FIG. 4 is a partial flow chart of the decision engine of method medical condition (e.g., diabetes) management system of FIG. 2.

FIG. 5 is a partial flow chart of the decision engine of method medical condition (e.g., diabetes) management system of FIGS. 2 and 3.

FIG. 6 is a partial flow chart of a COMPUTE SCORE algorithm of a solution scoring module of a decision engine of a method medical condition (e.g., diabetes) management system.

FIG. 7 is a partial flow chart of the COMPUTE SCORE algorithm of the solution scoring module of the decision engine of the method medical condition (e.g., diabetes) management system of FIG. 6.

FIG. 8 is a partial flow chart of a compute A1C SCORE algorithm of an A1C score module of a decision engine of a method of medical condition (e.g., diabetes) management system.

FIG. 9 is a partial flow chart of the compute A1C SCORE algorithm of the A1C score module of the decision engine of the method of medical condition management system of FIG. 8.

FIG. 10 is a partial flow chart of a COMPUTE COST SENSITIVITY SCORE algorithm of a cost sensitivity module of a decision engine of the method of medical condition management.

FIG. 11 is a partial flow chart of the COMPUTE COST SENSITIVITY SCORE algorithm of the costs is an sensitivity module of the decision engine of the method of medical condition management of FIG. 10.

FIG. 12 is a flow chart of a COMPUTE MECHANISM SCORE algorithm of a mechanism module of a decision engine of a method of medical condition management.

FIG. 13 is a flow chart of a COMPUTE BMI SCORE algorithm of a BMI scoring module of a decision engine of a method of medical condition management.

FIG. 14 is a partial flow chart of a COMPUTE SIDE EFFECT SCORE algorithm of a side effect score module of a decision engine of a method of medical condition management.

FIG. 15 is a partial flow chart of the COMPUTE SIDE EFFECT SCORE algorithm of the side effect score module of the decision engine of the method of medical condition management of FIG. 14.

FIG. 16 is a partial flow chart of the COMPUTE SIDE EFFECT SCORE algorithm of the side effect score module of the decision engine of the method of medical condition management of FIGS. 14 and 15.

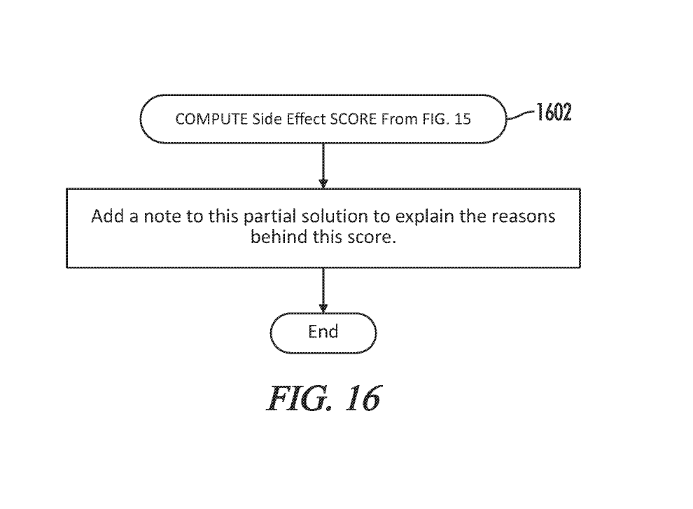

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The terms “coupled” and “connected” mean at least either a direct electrical connection between the connected items or an indirect connection through one or more passive or active intermediary devices.

The term “circuit” means at least either a single component or a multiplicity of components, either active and/or passive, that are coupled together to provide a desired function.

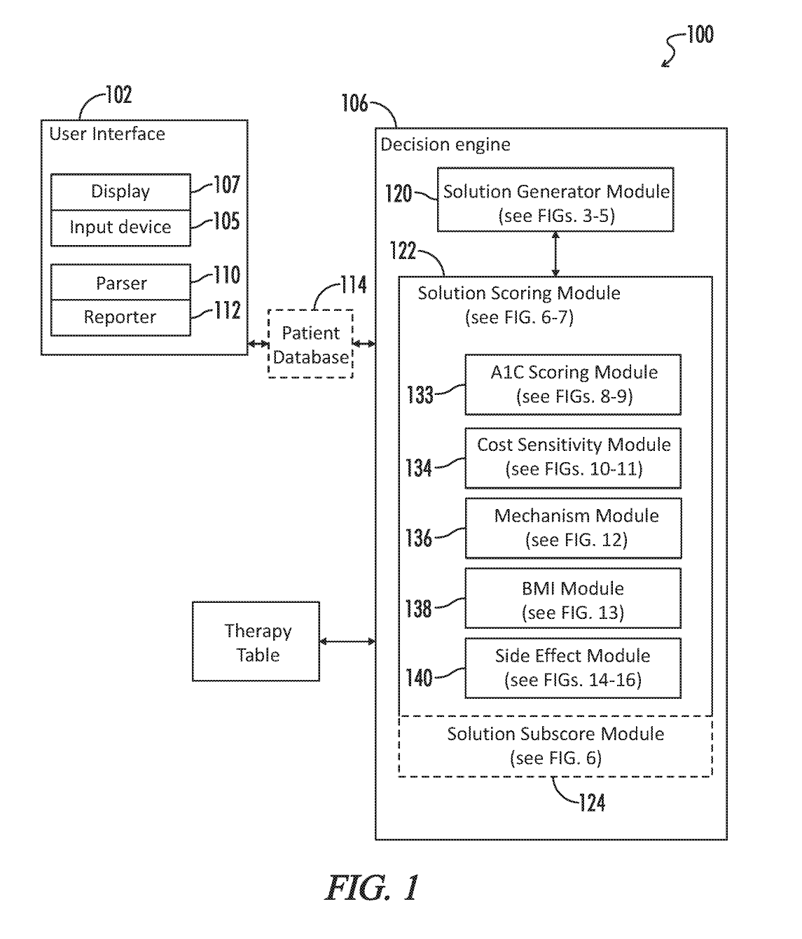

Referring to FIG. 1, a medical condition management system 100 includes a user interface 102, a therapy table 104, and a decision engine 106. The user interface 102 is configured to receive patient data and output a rank ordered list of solutions. In one embodiment, each solution of the rank ordered list of solutions is a combination of one or more therapies. The therapy table 104 is configured to store therapy data for each therapy of a plurality of therapies. The therapy data includes one or more of the following metrics: price, side effects, multi-therapy compatibility, insurance discounts, insurance reimbursements, and efficacy. The decision engine 106 is configured to receive the patient data from the user interface 102, received the therapy data from the therapy table 104, generate the rank ordered list of solutions from the receive patient data and therapy data, and provide the rank ordered list of solutions to the user interface 102.

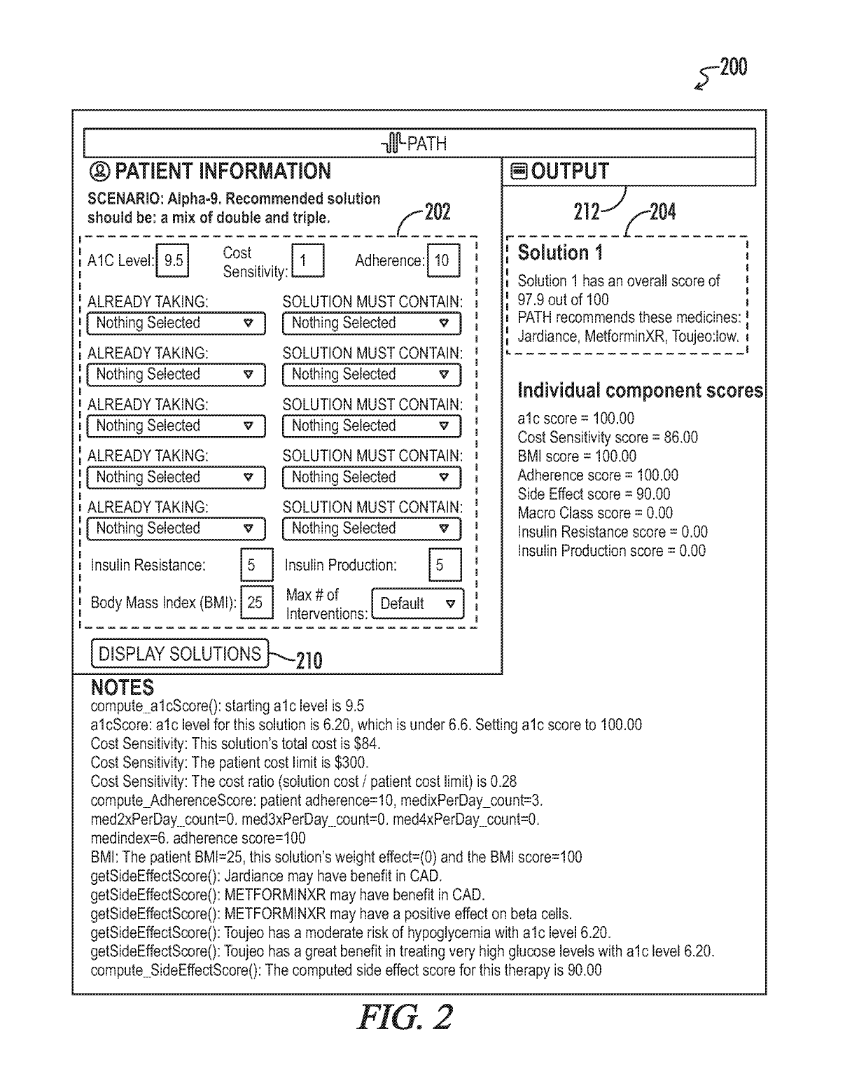

Referring to FIG. 2, one embodiment of an individual (i.e., single patient) user interface (UI) 200 version of user interface 102 is shown. This sample implementation is to support clinical decisions regarding diabetes treatment, so several of the questions are specific to that that disease and area of medicine. Other implementations of the system, such as one that suggests therapies for cardiovascular disease, would have questions specific to that area of medicine. The output of the UI is a list of suggested treatment recommendations, presented in sorted order, highest score first. User interface 102 includes an input device 105 (e.g. touchscreen buttons or mouse) to receive patient data from user and a display 107 (e.g. an LCD screen) configured to display the rank ordered list of solutions 204 to the user and show selected patient data 202 to the user.

The left side of the sample UI is titled PATIENT INFORMATION, and is designed to obtain data about the patient's medical history including A1C LEVEL, COST SENSITIVITY, ADHERENCE, ALREADY TAKING, SOLUTION MUST CONTAIN, ALLERGY, DRUG INTOLERANCE, FORGOT TO TAKE, INSURER, HAS COUPON FOR, COMORBID, PHYSICAL INTOLERANCE, SEX, INSULIN RESISTANCE, INSULIN PRODUCTION, BODY MASS INDEX, MAX # OF INTERVENTIONS, AND DISPLAY SOLUTIONS.

A1C LEVEL asks for the patient's current blood glucose level expressed as a percent. This is also commonly referred to in the literature as the “hemoglobin a1c”, “HbA1c” or “glycohemoglobin” level. It is also most commonly referred to as a percent.

COST SENSITIVITY asks the patient to rate how much money they can afford to pay for treatment of this disease. The sample UI implementation uses an integer 0-to-10 Likert scale, but other implementations (such as asking the user to enter a maximum dollar amount) are easily adapted. In this sample UI implementation, a value of 0 means the patient is able to afford any treatment that may be suggested. A value of 10 indicates the patient strongly prefers the lowest cost treatments that are possible.

ADHERENCE indicates how well the patient adheres to, has adhered to in the past, or is likely to adhere to in the future, a prescribed therapy regimen. For example, some diabetes medicines require the patient to remember to take a pill after each meal. If the patient forgets or is unable to take the pill after each meal, the medicine's therapeutic value is greatly diminished. Thus, the patient's ability to adhere to a treatment schedule needs to be taken into consideration when recommending a course of action. The sample UI implementation uses an integer 0-to-10 Likert scale, but other implementations are easily adapted. In this sample UI implementation, a value of 0 means the patient has great difficulty in adhering to a prescribed therapy regimen. A value of 10 means the patient can adhere to any therapy regimen prescribed.

ALREADY TAKING is used to indicate all of the therapies the patient is currently using as part of their treatment. It can contain a list of specific medicines (e.g., “Metformin” or “Glimeperide”) and their dosage (e.g., “Glimeperide 1 milligram daily”). It may also indicate that patient is following other treatments options that affect the underlying condition, such as diet or exercise. It is possible to indicate 0 or more therapies as “already taking.”

SOLUTION MUST CONTAIN is used to indicate all of the therapies that the suggested treatments must contain. This UI element can include a list of specific medicines (e.g., “Metformin” or “Glimeperide”) and their dosage (e.g., “Glimeperide 1 milligram daily”). It may also indicate that patient is following other treatments options that affect the underlying condition, such as diet or exercise, and that must be continued in any future therapy. It is possible to indicate 0 or more therapies as “must contain.”

ALLERGY is used to indicate all of the therapies that the patient is allergic to. This UI element can include a list of specific medicines (e.g., “Metformin” or “Glimeperide”). It may also indicate that patient cannot following other treatments options that affect the underlying condition, such as diet or exercise. For example, it may be difficult for a wheelchair-confined patient to get enough exercise. The system disqualifies treatment options that the patient is allergic to, and will not recommend those treatment options. It is possible to indicate 0 or more therapies as allergens.

DRUG INTOLERANCE is used to indicate all of the therapies for which the patient exhibits intolerance. This UI element can include a list of specific medicines (e.g., “Metformin” or “Glimeperide”) and their dosage (e.g., “Glimeperide 1 milligram daily”). It may also indicate that patient experiences unpleasant effects from other treatments options that affect the underlying condition, such as diet or exercise. It is possible to indicate 0 or more therapies as intolerant. Unlike ALLERGY, the system does not disqualify therapies listed in DRUG INTOLERANCE; it considers those therapies slightly worse than if the patient was not intolerant. In some cases, the best therapy still contains a specific medicine or treatment option that the patient is intolerant of. In these situations, a discussion of the trade-offs of the therapy benefits and intolerances will take place between the patient and medical professional.

FORGOT TO TAKE is used to indicate all of the therapies for which the patient has forgot to take in the past. This UI element can include a list of specific medicines (e.g., “Metformin” or “Glimeperide”) and their dosage (e.g., “Glimeperide 1 milligram daily”). It may also indicate that patient experiences show that the patient forgets to engage in other treatments options that affect the underlying condition, such as diet or exercise. It is possible to indicate 0 or more therapies as “Forgot to take.” Unlike ALLERGY, the system does not disqualify therapies listed in FORGOT TO TAKE; it considers those therapies slightly worse than if the patient remembered to take them.

INSURER is a list of health insurance providers (e.g., “Blue Cross/Blue Shield”, “Humana”, “Medicare”) for which the patient has a health insurance policy. More than one insurer may be selected, if the patient has more than one health insurance policy. It is possible to indicate 0 or more insurers.

HAS COUPON FOR is used to indicate all of the therapies for which the patient has a coupon that reduces the cost of the therapy. This UI element can include a list of specific medicines (e.g., “Metformin” or “Glimeperide”) and optionally their dosage (e.g., “Glimeperide 1 milligram daily”). It is possible to indicate 0 or more therapies, and 0 or more coupons.

COMORBID is used to indicate all of the patient's medical conditions. This UI element is a list of specific comorbidity factors (e.g., “Coronary Artery Disease” or “Chronic Heart Failure”). It may optionally include a list of past or future medical conditions, such as a history of smoking or the possibility of becoming pregnant. It is possible to indicate 0 or more comorbidity factors.

PHYSICAL INTOLERANCE is used to indicate the specific physical effects of medicines to which the patient may be susceptible. In the diabetes example, this list includes examples such as hypoglycemia; nausea; and yeast infections. It is possible to indicate 0 or more intolerances.

SEX is used to indicate whether the patient is male or female.

INSULIN RESISTANCE asks the medical professional to rate how much resistance the patient exhibits to normal glucose uptake. The sample UI implementation uses an integer 0-to-10 Likert scale, but other implementations are easily adapted (e.g., a non-linear scale, Homeostatic Model Assessment (HOMA) tests for insulin resistance, etc.). In this sample UI implementation, a value of 0 means the patient shows no signs of insulin resistance. A value of 10 indicates the patient is strongly resistant to glucose uptake.

INSULIN PRODUCTION asks the medical professional to rate how much insulin production the patient exhibits. The sample UI implementation uses an integer 0-to-10 Likert scale, but other implementations are easily adapted (e.g., a non-linear scale, HOMA tests for beta cell function, etc.). In this sample UI implementation, a value of 0 means the patient produces no insulin. A value of 10 indicates the patient's ability to produce insulin is not compromised.

BODY MASS INDEX asks for the patient's current Body Mass Index using the conventional calculation for Body Mass Index in either pounds or kilograms. That is, Body Mass Index is the patient's weight in kilograms divided by (patient's height in meters squared), or Body Mass Index is the patient's weight in pounds divided by the product of the patient's height in inches squared times 703. Other implementations are easily adapted, such as asking for the patient's height and weight directly.

MAX # OF INTERVENTIONS is the maximum number of therapies that the system should recommend per treatment option. In the example implementation, choices are 5 (the default) to 1. For example, if MAX # OF INTERVENTIONS is set to 3, then each solution offered by the system will contain 3 medicines or therapies at most.

DISPLAY SOLUTIONS is a button that begins the system's analysis of the data indicated by the UI elements. The process ends with the display of a set of solutions on the right side of the UI.

The right side of the UI is titled OUTPUT. This section contains an ordered list of therapy recommendations, sorted in order of descending potential benefit. Each therapy recommendation consists of 0 to max # of interventions RECOMMENDATIONS. These may be medicines (and optionally their doses) or other therapies, such as diet or exercise. In the example shown the first therapy recommendation consists of the medicines Jardiance, MetforminXR, and Toujeo:Low.

Each therapy recommendation in the OUTPUT section of the UI also includes an OVERALL SCORE, showing the quality of the solution. In the illustrated implementation, the scale used is from 0 to 100, with 100 being the highest potential score. In this embodiment, the scoring system is absolute; all solutions are scored independently on the same scale. However, any scoring system than can rank the therapy recommendations from most-to least-desirable can be used.

Each therapy recommendation in the OUTPUT section of the UI may also assign a separate score to each INDIVIDUAL COMPONENT of its decision-making process. In this implementation of the UI, the individual components for diabetes include an a1c score; cost sensitivity score; body mass index (BMI) score; adherence score; side effect score; macro class score; insulin resistance score; and insulin production score. The scale used in this implementation is from 0 to 100, with 100 the highest potential score, but other scoring systems or scales are possible.

The display of each individual component scores is meant to explain the reasoning behind the therapy recommendation to the medical professional and patient. For example, a high score in the area of cost sensitivity means that this therapy recommendation is particularly good at addressing the patient's cost concerns. The calculation of these scores is dependent on the implementation goals and many different methods can be used.

In addition to the individual component scores, the OUTPUT section of the UI may explain the reasoning that lead to the determination of a particular component score. In the example illustrated by FIG. 2, the solution's side effect score was increased because of the beneficial side effect that Jardiance and MetforminXR have in treating CAD (Coronary Artery Disease), and MetforminXR's positive effect on beta cells. Other examples of notes displayed along side recommended therapies in the OUTPUT section of the UI include why a particular drug was disqualified from solutions, such as allergy, conflicts with other drugs, or cost.

In one embodiment, the major components of a medical condition (e.g., diabetes) management system and methods include the user interface 102, a patient database 114, a therapy table 104, a solution generator module 120, a solution scoring module 122, and a solution subscore coefficient module 124. The solution subscore coefficient module 124 may be integral with the solution scoring module 122 or may integrated into each of the modules by providing scores that are on different scales wherein the size of the scale correlates to the weighting of the score such that the scores may simply be summed by the solution scoring module 122 and the solution subscore module 124 becomes optional. This description uses the area of diabetes treatment as an example to illustrate the major components of the clinical decision support system 100 and methods. However, the invention is not limited to diabetes, and the invention can be applied to decision support of other diseases and medical conditions.

USER INTERFACE 102—The user interface collects relevant information about the patient's medical condition. The user interface 200 contains a series of input prompts or questions that must be answered by either a patient or a medical professional. For example, one prompt might ask whether the patient was male or female; another prompt might ask the user to specify the medicines to which the patient may be allergic to or intolerant of. The USER INTERFACE 200 also contains a series of prompts that allow the medical professional to control the number of distinct therapies that are contained in each solution. For example, the medical professional may indicate through the USER INTERFACE 200 that each solution may contain a maximum of 3 therapies.

The USER INTERFACE 200 is typically displayed on a computing device, such as desktop computer, tablet, or mobile phone. It may also be a physical form, such as a paper questionnaire, that is later transferred to a computer.

The USER INTERFACE 200 also contains a mechanism for the user to indicate that they have completed this data entry process. In the example of FIG. 2, that mechanism is a virtual button 210 labeled “Display solutions.” When this mechanism 210 is activated, the SOLUTION GENERATOR MODULE is run. The output of the SOLUTION GENERATOR MODULE is a list of recommended therapies.

The USER INTERFACE 200 also contains an output section 212. The output section 212 is used to display a set of zero or more solutions and their scores, in descending order of score (where a higher score indicates a more preferred solution).

In addition to the prompts and questions about the patient's medical condition, the USER INTERFACE 200 may also provide the medical professional the ability to specify a specific solution or therapy, to run the SOLUTION SCORING MODEL on that solution and display the solution score in the output section of the USER INTERFACE 200. Thus, the medical professional may test various “what-if” scenarios using the system's SOLUTION SCORING MODEL.

In another embodiment, the user interface 102 is a batch interface including a parser 110 and a reporter 112. The parser 110 is configured to receive a batch of patient data for each of a plurality of patients from a data source. The parser 110 parses the received bastion the patient data for each patient of the plurality of patients, and the parsed patient data may be stored in the patient database 114. The parser 110 serially provides the patient data for each patient a plurality of patients to the decision engine 106. The decision engine 106 serially returns a list of rank ordered solutions for each patient. In one variation, the parser 110 provides a table of patient data including patient data for each of a plurality of patients to the decision engine 106. The decision engine 106 institutes multiple instances of the solution generator module 120 and or solution scoring module 122, and provides a rank ordered list of solutions for each patient of the plurality of patients to the reporter 112. The reporter 112 aggregates on a patient by patient basis the rank ordered lists of solution received from the decision engine 106 and provides the aggregated rank ordered lists of solutions to the data source, each rank ordered list of solutions indicated as corresponding to one of the patients of the plurality of patients. That is, the reporter 112 aggregates the table of patient data and rank ordered lists of solutions and provides the aggregated table has an output from the system 100.

PATIENT DATABASE 114—This optional component may be used to store patient data for later retrieval and use. One purpose of the database 114 would be to avoid the user from having to answer some of the USER INTERFACE prompts each time the USER INTERFACE 200 is run, thus saving the user time and preventing data entry errors.

For example, the PATIENT DATABASE could store data that indicates a particular patient is allergic to a specific medicine. Instead of requiring the patient or medical professional to answer that input prompt multiple times over the patient's course of treatment, it could be retrieved from the PATIENT DATABASE, displayed on the USER INTERFACE 200, and confirmed by the medical professional.

THERAPY TABLE 104—The THERAPY TABLE 104 stores information about each therapy that can be used to treat the patient's medical condition under consideration by the system. Each entry in the THERAPY TABLE 104 contains information about one therapy. Examples of information about a therapy which may be stored in the THERAPY TABLE 104 include:
therapy name (e.g., “Glimeperide”)
dosage (e.g., “1 milligram daily” or “Low”)
therapeutic effect (e.g., “Reduces blood glucose levels 1.2 percent on average”)
cost under various medical insurance plans (e.g., “AETNA $75”)
side effects (e.g., “May cause nausea”)
administration method (e.g., “Injectable” or “oral”)
frequency (e.g., “Once per day”)
mechanism of action (e.g., “Basal insulin”)
contraindications (e.g., “May cause renal failure”)
effect on body mass index (e.g., “Moderate weight gain”, “Significant weight gain”) macro class (e.g., “Sensitizer”)

The THERAPY TABLE 14 may be stored as a computer database, computer file, or in other means accessible by the system. It is contemplated that the patient database 114 and the therapy table 104 may be stored in the same database. Similarly, cost and insurance reimbursement data may be stored in the same therapy table 104, or the cost and insurance reimbursement data may be separated out into another table database accessible by the decision engine 106.

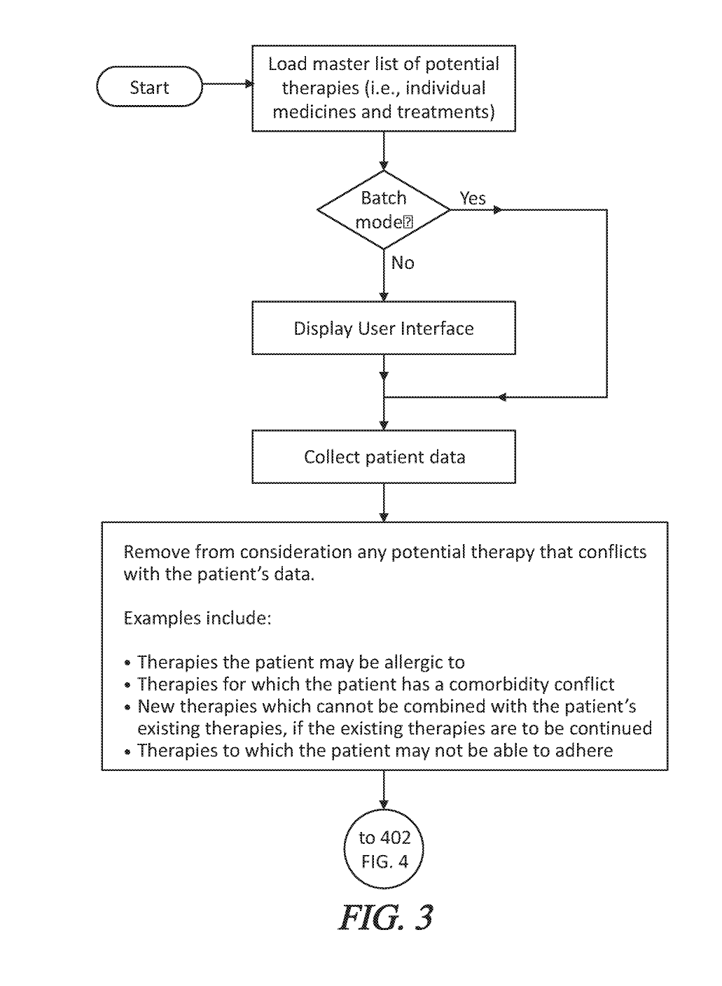

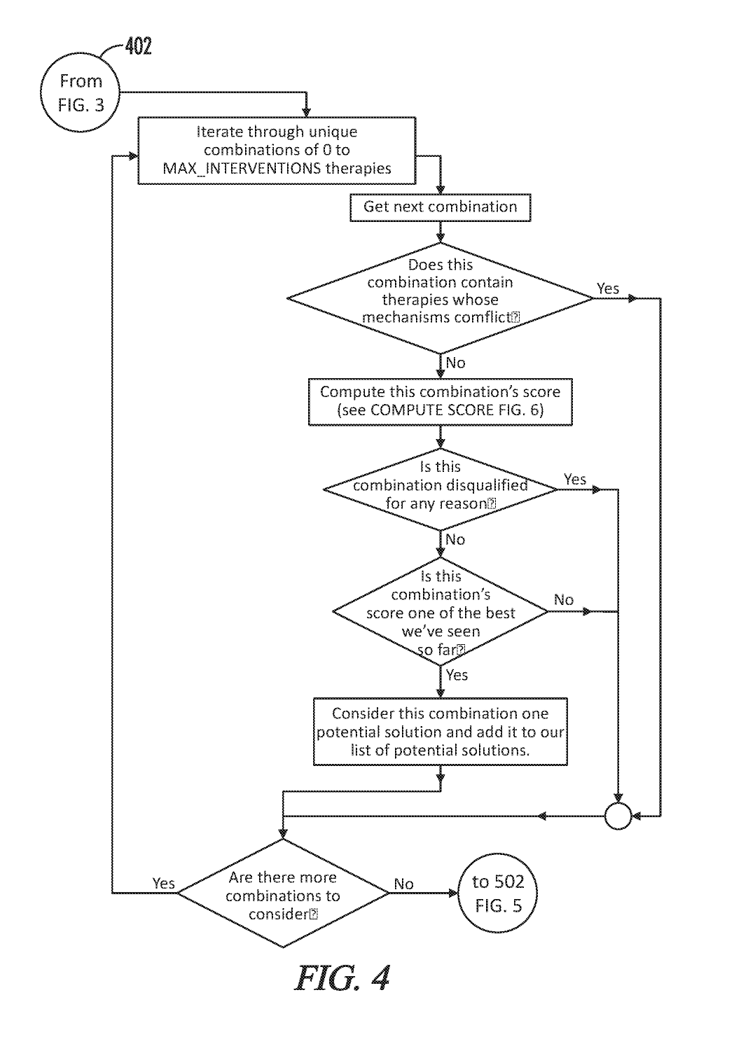

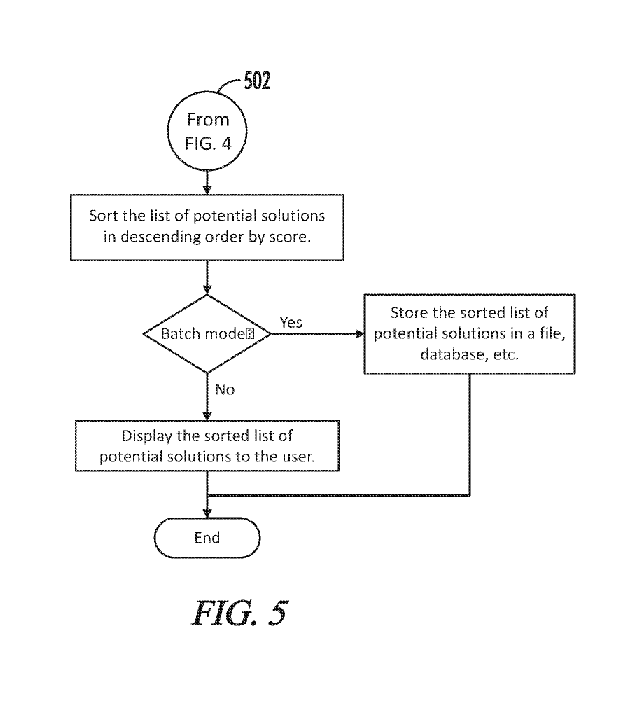

Referring to FIGS. 3-6, a solution generator module 120 is configured to determine a list of solutions as a function of the patient data and the therapy data. Determining the list of solutions includes eliminating solutions as a function of the patient data to generate a list of compatible solutions and returning list of compatible solutions as the list of solutions.

SOLUTION GENERATOR MODULE—The SOLUTION GENERATOR MODULE generates unique combinations of therapies from the THERAPY TABLE 104. This unique combination of therapies is called a solution or therapy. The mechanism by which the unique combination of therapies is generated may be deterministic or random.

The SOLUTION GENERATOR MODULE runs the SOLUTION SCORING MODEL (i.e., module) 122 for each solution (e.g., therapy) generated, to determine a solution score. If this solution score is greater than the lowest solution score of any solution previously found in the list of recommended solutions, then the previously found solution with the lowest solution score is deleted from the list of recommended solutions, and the current solution is added to the list of recommended solutions.

A user-configurable number of solutions is retained in the list of recommended solutions, with a minimum of one solutions retained.

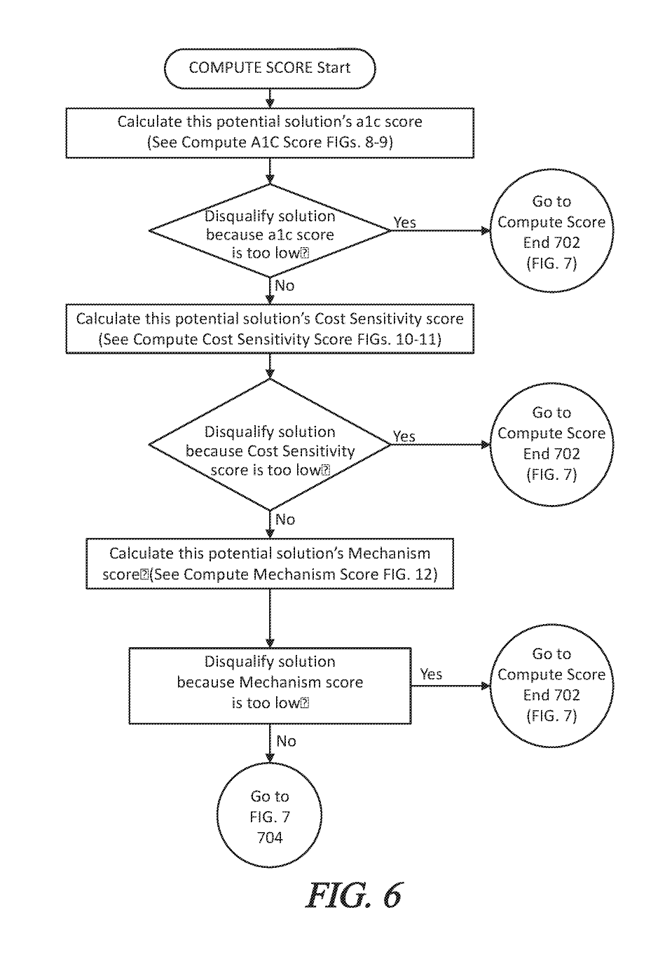

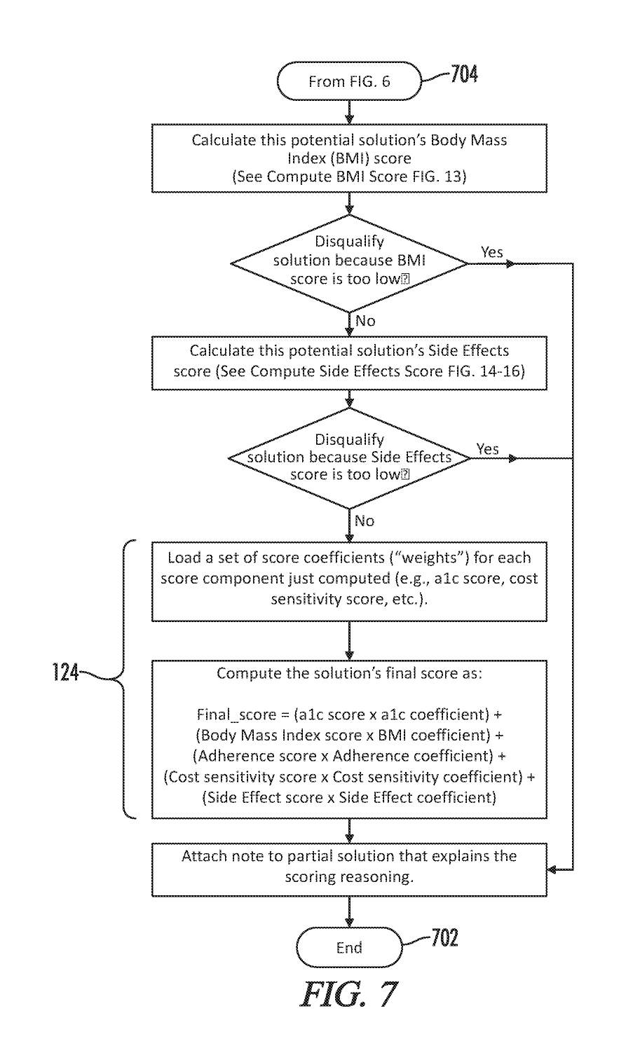

Referring to FIGS. 6-7, SOLUTION SCORING MODULE 122 or compute score module 122 is shown. The SOLUTION SCORING MODEL 122 calculates the expected benefit to the patient if the patient followed the therapies contained in the solution. This expected benefit is typically expressed as a number (e.g., on a 0 to 100 scale, with 100 representing the best possible score), and is called the solution score; other representations of benefit are possible as a solution score (e.g., “Disqualified”, “Not likely to be effective”, “Somewhat likely to be effective”, and “Likely to be effective”).

The SOLUTION SCORING MODEL 122 may aggregate the results of zero or more SOLUTION SUBSCORE MODULEs to calculate the SOLUTION's expected benefit. For example, in the treatment of Type 2 Diabetes, the SOLUTION SCORING MODEL may use a separate SOLUTION SUBSCORE MODULE to rate the solution's ability to reduce the patient's blood glucose levels; and another SOLUTION SUBSCORE MODULE to rate the solution's cost relative to the patient's ability to afford it.

SOLUTION SUBSCORE COEFFICIENT MODULE 124—The SOLUTION SCORING MODULE 124 may associate a SOLUTION SUBSCORE COEFFICIENT with each SOLUTION SUBSCORING MODULE. The SOLUTION SCORING MODULE may multiple the SOLUTION SUBSCORE COEFFICIENT by the SOLUTION SUBSCORING MODULE score to get a weighted representation of the value contributed to the solution by the particular attribute represented in the SOLUTION SUBSCORING MODULE. For example, the system may be configured so that the cost of any SOLUTION is weighted twice as much as the SOLUTION's effect on Body Mass Index.

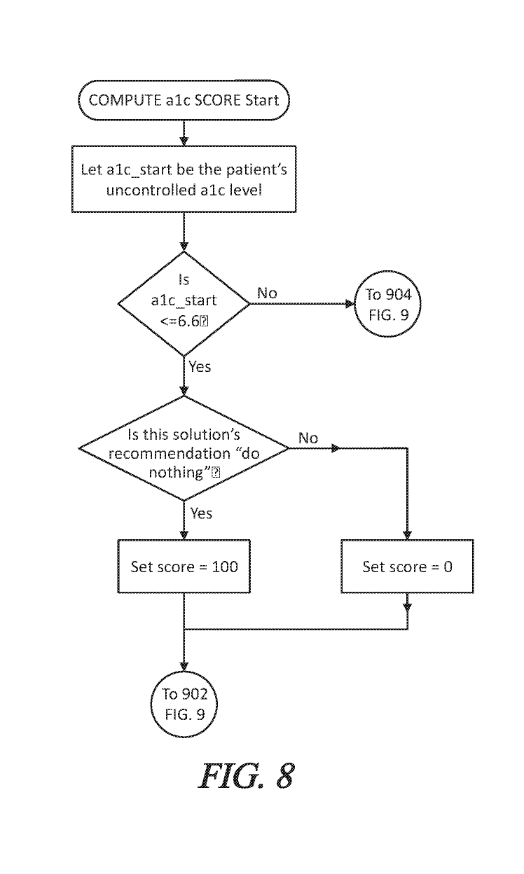

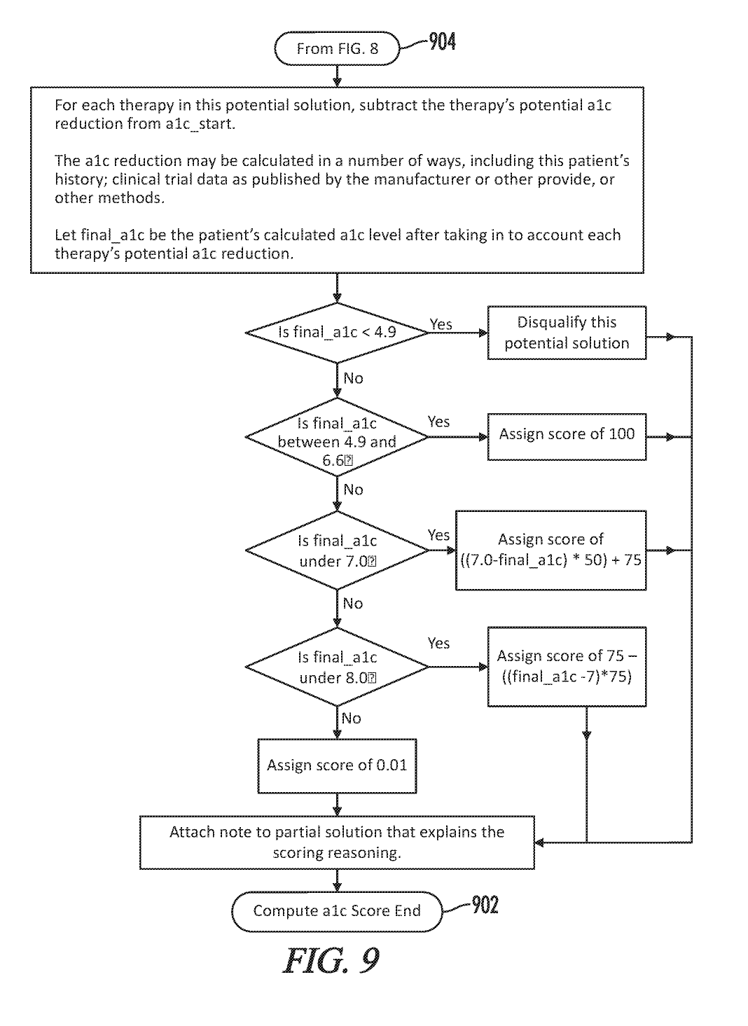

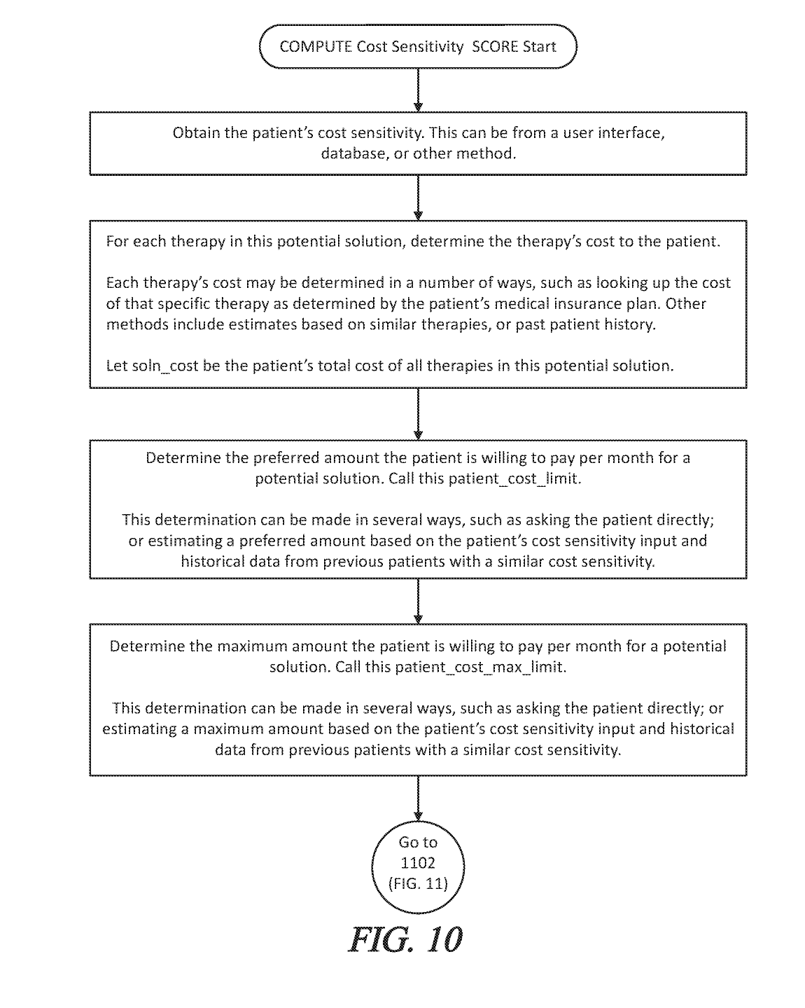

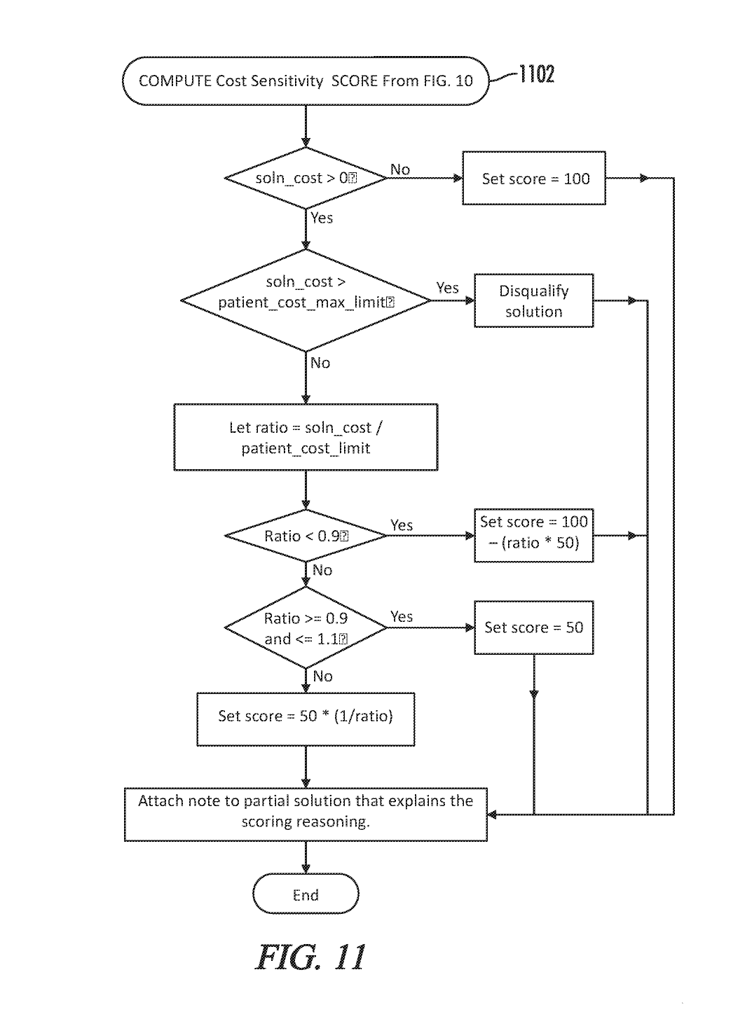

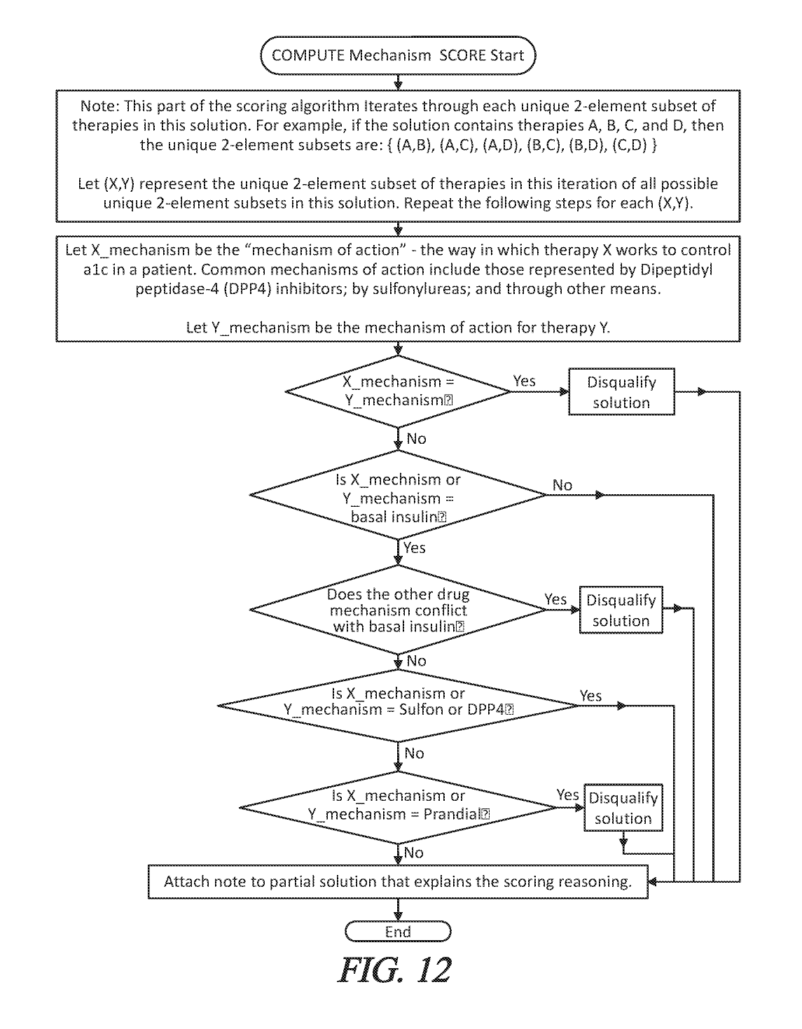

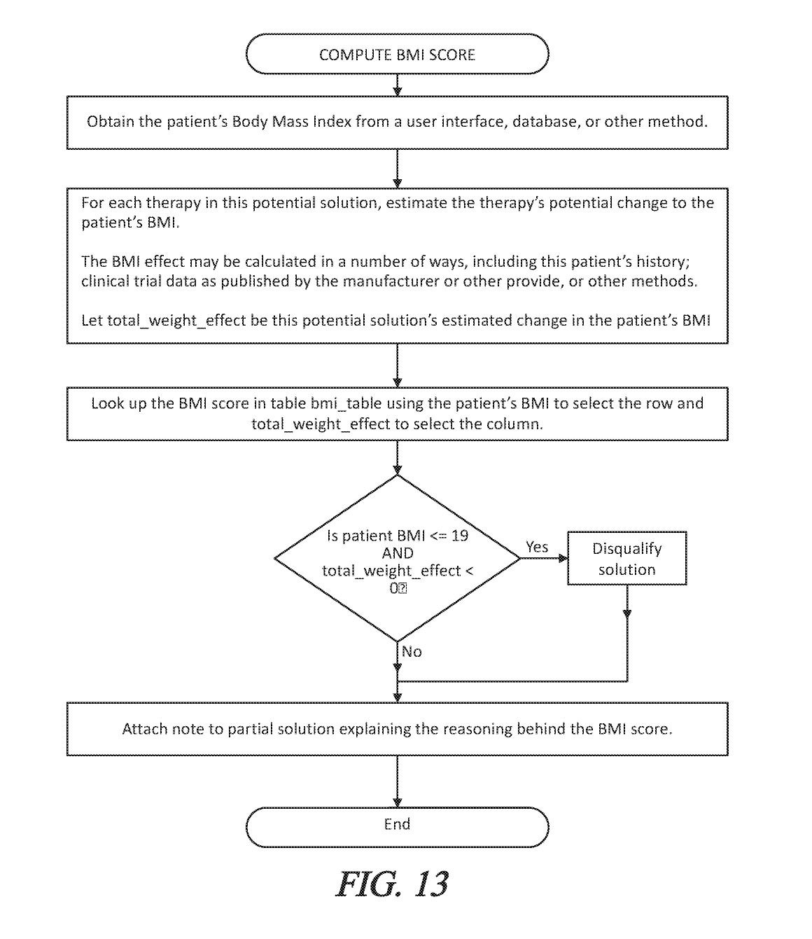

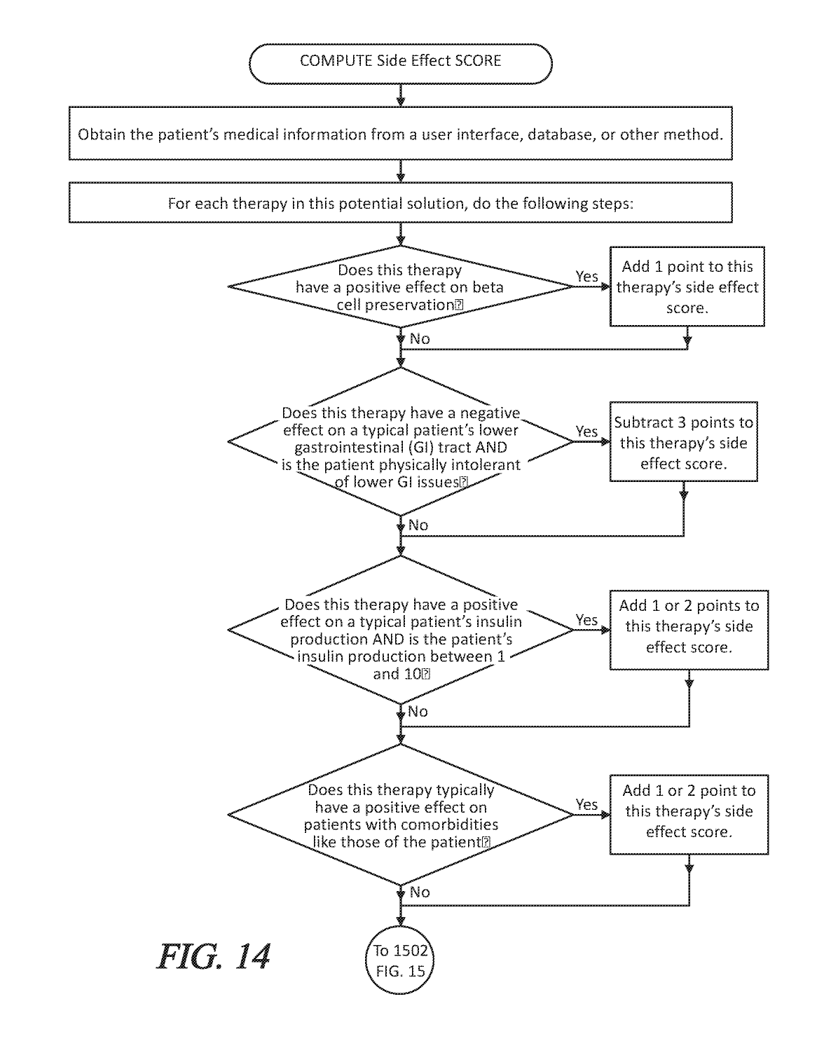

SOLUTION SUBSCORING MODULE 124—This component of the system determines a score for a particular attribute of a solution, such as its cost or side effects. For the treatment of Type 2 Diabetes, for example, the system may contain these SOLUTION SUBSCORING MODULES:
A1C reduction module 133 and algorithm (see FIG. 8-9)
Cost sensitivity module and algorithm 134 (see FIGS. 10-11)
Mechanism Module 136 and algorithm (see FIG. 12)
Body Mass Index effects module 138 and algorithm (see FIG. 13)
Side effects module 140 and algorithm (see FIG. 14)

BATCH MODE MODULE (optional)—A doctor, hospital, or other entity may want to run the SOLUTION GENERATOR MODULE on many patients without having to input the data into the USER INTERFACE. For example, a hospital may want to estimate the number of times the app might suggest the drug FARXIGA, across the hospital's entire population of patients. The application is able to read a collection of patient data records from a database, data file, and other electronic means, in what is commonly referred to as “batch mode.” When presented with a collection of patient data records, the BATCH MODE MODULE processes each patient record separately by invoking the SOLUTION GENERATOR MODULE as described above. The solutions generated by the SOLUTION GENERATOR MODULE are saved to a database, data file, or other electronic medium instead of being displayed on the USER INTERFACE.

PRICE AND REVENUE OPTIMIZATION MODULE—The PRICE AND REVENUE OPTIMIZATION MODULE is be used by doctors, hospitals, drug manufacturers, and other entities to optimize the price or revenue generated by diabetes treatments. The PRICE AND REVENUE OPTIMIZATION MODULE allows these entities to determine how many times a specific treatment is recommended over a population, such as a hospital's entire population of patients.

For example, the manufacturer of the diabetes drug FARXIGA may use the BATCH MODE MODULE on a database of diabetes patients in the greater Cincinnati metropolitan area to maximize the revenue generated by the drug FARXIGA across that population.

The BATCH MODE MODULE calculates how many times the drug FARXIGA would be recommended by the SOLUTION GENERATOR MODULE for that population, at FARXIGA's current price point. The manufacturer will then use the PRICE AND REVENUE OPTIMIZATION MODULE to set a range of hypothetical price points for the drug FARXIGA.

The PRICE AND REVENUE OPTIMIZATION MODULE will then re-run the BATCH MODE MODULE on the same database of diabetes patients, and calculate how many times the drug FARXIGA would be recommended by the SOLUTION GENERATOR MODULE at each price point. The manufacturer's total revenue at each price point is calculated by multiplying the total number of recommendations by the price point.

The manufacturer knows the total cost of supplying the drug FARXIGA to a patient, including common expenses such as raw ingredients, research, manufacturing, advertising, and incentives or rebates. Thus the manufacturer can calculate its gross and net revenue for each price point to determine the optimal price point for the drug FARXIGA.

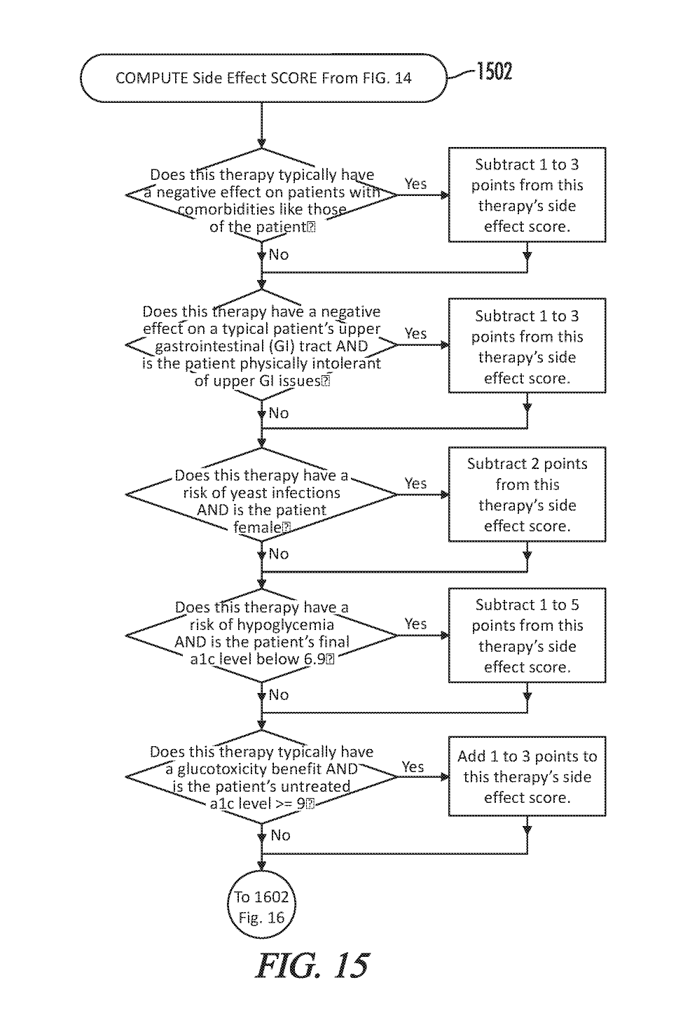

Referring to FIGS. 3-15, one embodiment of a medical condition management system and method 100 is illustrated. The illustrated medical condition management system is for managing diabetes care.

It will be understood by those of skill in the art that navigating between user interface views is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful MEDICAL CONDITION MANAGEMENT SYSTEM AND METHODS it is not intended that such references be construed as limitations upon the scope of this invention except as set forth in the following claims.

What is claimed is:

1. A medical condition management system comprising:
a user interface configured to receive patient data and output a rank ordered list of solutions;
a therapy table configured to store therapy data for each therapy of a plurality of therapies, said therapy data comprising at least one of the following metrics: price, side effects, multi-therapy compatibility, insurance discounts, insurance reimbursements, or efficacy; and
a decision engine configured to:
receive the patient data from the user interface;
receive the therapy data from the therapy table;
generate the rank ordered list of solutions from the received patient data and therapy data; and
provide the rank ordered list of solutions to the user interface.

2. The medical condition management system of claim 1, wherein the decision engine comprises:
a solution generator module configured to determine a list of solutions as a function of the patient data and the therapy data, wherein determining the list of solutions comprises eliminating solutions as a function of the patient data to generate a list of compatible solutions and returning the list of compatible solutions as the list of solutions.

3. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution, and wherein the decision engine is configured to determine the rank ordered list of solutions as a function of the plurality of scores for each solution of the list of solutions.

4. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution; and wherein the solution scoring module comprises:
a solution subscore coefficient module configured to weight each score generated by the solution scoring module for each solution in the list of solutions and determine an overall score for each solution in the list of solutions score each solution in the list of solutions and wherein the decision engine is configured to determine the rank ordered list of solutions as a function of the overall score for each solution in the list of solutions.

5. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution; and wherein the solution scoring module comprises:
an A1C score module configured to calculate an A1C score as a function of a given solution, the patient data, and clinical trial data corresponding to the given solution.

6. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution; and wherein the therapy data comprises a cost of the given solution and the solution scoring module comprises:
a cost sensitivity module configured to determine a cost score as a function of the cost of the given solution and cost sensitivity data of the patient data for the patient.

7. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution; and wherein the solution scoring module comprises:
a mechanism module configured to eliminate solutions as a function of an action mechanism of therapy of a given solution, wherein the mechanism module eliminates the given solution when the action mechanism of two therapies are the same or contraindicate one another.

8. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution; and wherein the solution scoring module comprises:
a body mass index (BMI) scoring module configured to determine a BMI score representative of the effect on BMI change of the given function for the patient as a function of clinical trial data for the given solution and patient BMI from the patient data.

9. The medical condition management system of claim 1, wherein the decision engine comprises:
a solution scoring module configured to generate a plurality of scores for each solution in the list of solutions, wherein each score of the plurality of scores is based on different criteria defining different success metrics for a given solution; and wherein the solution scoring module comprises:
a side effect score module configured to determine a side effect score as a function of the patient data and clinical trial data corresponding to the given solution, wherein the clinical trial data is representative of side effects of the given solution or a therapy of the given solution.

10. The medical condition management system of claim 1, wherein the user interface is an individual user interface comprising:
an input device configured to receive patient data from a user; and
a display configured to display a rank ordered list of solutions to the user.

11. The medical condition management system of claim 1, wherein the user interface is a batch interface comprising:
a parser configured to:
receive a batch of patient data for each of a plurality of patients from a data source;
parse the received batch into patient data for each patient of the plurality of patients; and
serially provide the patient data for each patient of the plurality of patients to the decision engine; and
a reporter configured to:
receive, from the decision engine, the rank ordered list of solutions for each patient of the plurality of patients;
aggregate, on a patient by patient basis, the rank ordered lists of solutions received from the decision engine; and
provide the aggregated rank ordered lists of solutions to the data source.

12. The medical condition management system of claim 1, wherein the user interface is a batch interface comprising:
a parser configured to:
receive a batch of patient data for each of a plurality of patients from a data source;
parse the received batch into patient data for each patient of the plurality of patients; and
provide the patient data for each patient of the plurality of patients to the decision engine; and
a reporter configured to:
receive, from the decision engine, the rank ordered list of solutions for each patient of the plurality of patients;
aggregate, on a patient by patient basis, the rank ordered lists of solutions received from the decision engine; and
provide the aggregated rank ordered lists of solutions to the data source; wherein
the decision engine is configured to institute a plurality of parallel instances of the decision engine, each instance of the decision engine providing at least one rank ordered list of solutions to the reporter.

13. A medical condition management system comprising:
a user interface configured to receive patient data and output a rank ordered list of solutions;
a therapy table configured to store therapy data for each therapy of a plurality of therapies, said therapy data comprising price, side effects, multi-therapy compatibility, insurance discounts, insurance reimbursements, and efficacy; and
a means for:
receiving the patient data from the user interface;
receiving the therapy data from the therapy table;
generating the rank ordered list of solutions from the received patient data and therapy data; and
providing the rank ordered list of solutions to the user interface, wherein said means is a decision engine.

14. The medical condition management system of claim 13, wherein the decision engine comprises means for:
determining a list of solutions as a function of the patient data and the therapy data, wherein determining the list of solutions comprises eliminating solutions as a function of the patient data to generate a list of compatible solutions and returning the list of compatible solutions as the list of solutions, wherein said means is a solution generator module.

15. The medical condition management system of claim 13, wherein the decision engine comprises:
a means for generating a plurality of scores for each solution in the list of solutions, wherein each score of the plurality of scores is based on different criteria defining different success metrics for a given solution, and wherein the decision engine is configured to determine the rank ordered list of solutions as a function of the plurality of scores for each solution of the list of solutions, wherein said means is a solution scoring module.

16. The medical condition management system of claim 13, wherein the decision engine comprises:
a means for generating a plurality of scores for each solution in the list of solutions, wherein each score of the plurality of scores is based on different criteria defining different success metrics for a given solution; and wherein said means is a solution scoring module and the solution scoring module comprises:
a solution subscore coefficient module configured to weight each score generated by the solution scoring module for each solution in the list of solutions and determine an overall score for each solution in the list of solutions score each solution in the list of solutions and wherein the decision engine is configured to determine the rank ordered list of solutions as a function of the overall score for each solution in the list of solutions.

17. The medical condition management system of claim 13, wherein the decision engine comprises:
a means for generating a plurality of scores for each solution in the list of solutions, wherein each score of the plurality of scores is based on different criteria defining different success metrics for a given solution; and wherein said means is a solution scoring module and the solution scoring module comprises:
an A1C score module configured to calculate an A1C score as a function of a given solution, the patient data, and clinical trial data corresponding to the given solution.

18. The medical condition management system of claim 13, wherein the decision engine comprises:
a means for generating a plurality of scores for each solution in the list of solutions, wherein each score of the plurality of scores is based on different criteria defining different success metrics for a given solution; and wherein the therapy data comprises a cost of the given solution, said means is a solution scoring module, and the solution scoring module comprises:
a cost sensitivity module configured to determine a cost score as a function of the cost of the given solution and cost sensitivity data of the patient data for the patient.

19. The medical condition management system of claim 13, wherein the decision engine comprises:
a means for generating a plurality of scores for each solution in the list of solutions, wherein each score of the plurality of scores is based on different criteria defining different success metrics for a given solution; and wherein said means is a solution scoring module and the solution scoring module comprises:
a mechanism module configured to eliminate solutions as a function of an action mechanism of therapy of a given solution, wherein the mechanism module eliminates the given solution when the action mechanism of two therapies are the same or contraindicate one another.

20. The medical condition management system of claim 13, wherein the decision engine comprises:
a means for generating a plurality of scores for each solution in the list of solutions, wherein each score of the plurality of scores is based on different criteria defining different success metrics for a given solution; and wherein said means is a solution scoring module and the solution scoring module comprises:
a body mass index (BMI) scoring module configured to determine a BMI score representative of the effect on BMI change of the given function for the patient as a function of clinical trial data for the given solution and patient BMI from the patient data.
